(19) United States
(12) Patent Application Publication
(10) Pub. No.: US 2024/0243592 A1
(43) Pub. Date: Jul. 18, 2024

(54) ENERGY CONVERSION DEVICE AND BATTERY CHARGER ASSEMBLY

(71) Applicant: Scorpion Steel, LLC, Bingham Farms, MI (US)

(72) Inventors: Louis N. Radden, Bloomfield Hills, MI (US); Christopher Cole, Birmingham, MI (US)

(21) Appl. No.: 18/416,412

(22) Filed: Jan. 18, 2024

Related U.S. Application Data
(60) Provisional application No. 63/439,726, filed on Jan. 18, 2023.

(51) Int. Cl. H02J 7/00; H01F 7/20; H02K 35/02; H02M 7/00

(52) U.S. Cl. CPC H02J 7/0042; H01F 7/20; H02J 7/0068; H02K 35/02; H02M 7/003

(57) ABSTRACT

Embodiments herein are directed to an energy device. The energy device includes a housing, an insert sleeve, a magnet, and a control circuit. The insert sleeve has a through bore, and is positioned within a bore of the housing. The insert sleeve has an exterior surface and at least one coil solenoid positioned on the exterior surface. The magnet is configured to traverse the through bore to generate an energy through induction with the at least one coil solenoid. The control circuit includes a battery and an electrical connection interface and is communicatively coupled to the at least one coil solenoid. When the magnet is manually forced to traverse the through bore in a repetitive manner, an oscillation of the magnet generates the energy through induction with the at least one coil solenoid such that the battery is energized to provide a charging energy to an external personal electronic device.

### CROSS REFERENCE TO RELATED APPLICATIONS

This utility patent application claims priority benefit from U.S. Provisional Patent Application Ser. No. 63/439,726, filed on Jan. 18, 2023, the entire contents of which is incorporated herein in its entirety.

### TECHNICAL FIELD

The present specification generally relates to a battery charger assembly, and, more specifically, to an energy conversion device configured for battery charging.

### BACKGROUND

Electronic mobile devices, such as tablets, mobile phones, laptops, and/or the like are used by virtually everyone today. These devices are now relied upon in most everyone everyday lives whether for business or personal use. At the same time, people are busier than in years past and are always on the move, whether travelling for business and/or busy with getting the kids to the places they need to be. As such, these devices are not always electrically coupled to a charging device. As such, these devices use a battery to supply the power needed to function. However, people are not always in a place or in a position to have their electronic device charging via an Alternating Current (AC) adapter plugged into an electrical outlet, a wireless charging station, a portable charger battery, and/or the like.

Accordingly, a need exists for a user to generate enough power to charge their electronic mobile device regardless of where the user is located or if electrical outlets are nearby.

### SUMMARY

In one embodiment, an energy conversion device is provided. The energy conversion device includes a housing, an insert sleeve, a magnet, and a control circuit. The housing has a bore. The insert sleeve has a through bore. The insert sleeve is positioned within the bore of the housing. The insert sleeve has an exterior surface and a plurality of spaced apart partial rings extending from the exterior surface. At least one coil solenoid is positioned on the exterior surface. The at least one coil solenoid configured to generate a predetermined controlled magnetic field. The magnet configured to traverse the through bore to generate a kinetic and an electromagnetic energy through induction with the predetermined controlled magnetic field. The control circuit communicatively coupled to the at least one coil solenoid. The control circuit has a battery configured to be recharged by the kinetic and the electromagnetic energy and discharged by an electrical connection interface, a processor configured to control a charging and discharging of the battery, and at least one light emitting diode configured to display different colors based on a current status of the energy conversion device. When the magnet is manually forced to traverse the through bore in a repetitive manner, an oscillation of the magnet generates the kinetic and the electromagnetic energy through induction with the predetermined controlled magnetic field of the at least one coil solenoid such that the battery is energized to provide a charging energy to the electrical connection interface to provide an electrical charge to an external personal electronic device.

In another embodiment, an energy device is provided. The energy device includes a housing, an insert sleeve, a magnet, and a control circuit. The housing has a bore. The insert sleeve has a through bore. The insert sleeve is positioned within the bore of the housing. The insert sleeve has an exterior surface and at least one coil solenoid positioned on the exterior surface. The magnet is configured to traverse the through bore to generate an energy through induction with the at least one coil solenoid. The control circuit includes a battery and an electrical connection interface. The control circuit is communicatively coupled to the at least one coil solenoid. When the magnet is manually forced to traverse the through bore in a repetitive manner, an oscillation of the magnet generates the energy through induction with the at least one coil solenoid such that the battery is energized to provide a charging energy to an external personal electronic device via the electrical connection interface.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts an exploded view of an energy conversion device according to one or more embodiments shown and described herein;

FIG. 2 schematically depicts an assembled perspective view of the energy conversion device of FIG. 1 with a magnet moved to one end of a housing according to one or more embodiments shown and described herein;

FIG. 3 schematically depicts the assembled perspective view of the energy conversion device of FIG. 2 with the magnet moved to an other end of the housing according to one or more embodiments shown and described herein;

FIG. 4 schematically depicts a cross sectional view of a sleeve insert of the energy conversion device of FIG. 1 taken from line 2-2 according to one or more embodiments shown and described herein;

FIG. 5 schematically depicts a plan end view of a battery compartment of the energy conversion device of FIG. 1 according to one or more embodiments shown and described herein;

FIG. 6A schematically depicts a plan top view of a first circuit board of the energy conversion device of FIG. 1 according to one or more embodiments shown and described herein;

FIG. 6B schematically depicts a plan top view of one aspect of a second circuit board of the energy conversion device of FIG. 1 according to one or more embodiments shown and described herein;

FIG. 6C schematically depicts a plan top view of a second aspect of a second circuit board of the energy conversion device of FIG. 1 according to one or more embodiments shown and described herein;

FIG. 7 schematically depicts an illustrative electrical circuit diagram for an electrical control circuit of the energy conversion device of FIG. 1 according to one or more embodiments shown and described herein;

FIG. 8 schematically depicts a plan view of an inside surface of a first end cap of the energy conversion device of FIG. 1 according to one or more embodiments shown and described herein; and

FIG. 9 schematically depicts a plan view of an inside surface of a second end cap of the energy conversion device of FIG. 1 according to one or more embodiments shown and described herein.

### DETAILED DESCRIPTION

Embodiments described herein are related to an energy conversion device that stores or harvests both kinetic and electromagnetic energy such that the harvested energy may be used to charge a personal electronic device. Further, in embodiments described herein, the energy conversion device may be used for generating kinetic and electromagnetic energy (electricity) that may be used for, or delivered to, electronics and non-electronic mechanisms. The energy conversion device may include a housing, a printed circuit board (PCB), a circuit assembly, a magnet, at least one coil solenoid, end caps, a battery assembly, and at least one light emitting diode configured to light during the harvesting process and/or when there is sufficient energy stored. The energy conversion device is configured to be shaken, which in turn creates and harvests energy in the form of high voltage and milliamp Hour (mAh) to be converted for use in applications such as charging personal electronic devices. The energy conversion device may be used to charge the personal electronic device whenever there may be an emergency, at an airport, during camping, and in general for on-to-go people who do not have time to use conventional AC chargers.

The phrase “communicatively coupled” is used herein to describe the interconnectivity of various components of the energy conversion device for selectively generating, storing, and/or transmitting energy means that the components are connected either through wires, optical fibers, or wirelessly such that electrical, optical, and/or electromagnetic signals may be exchanged between the components. It should be understood that other means of connecting the various components of the system not specifically described herein are included without departing from the scope of the present disclosure.

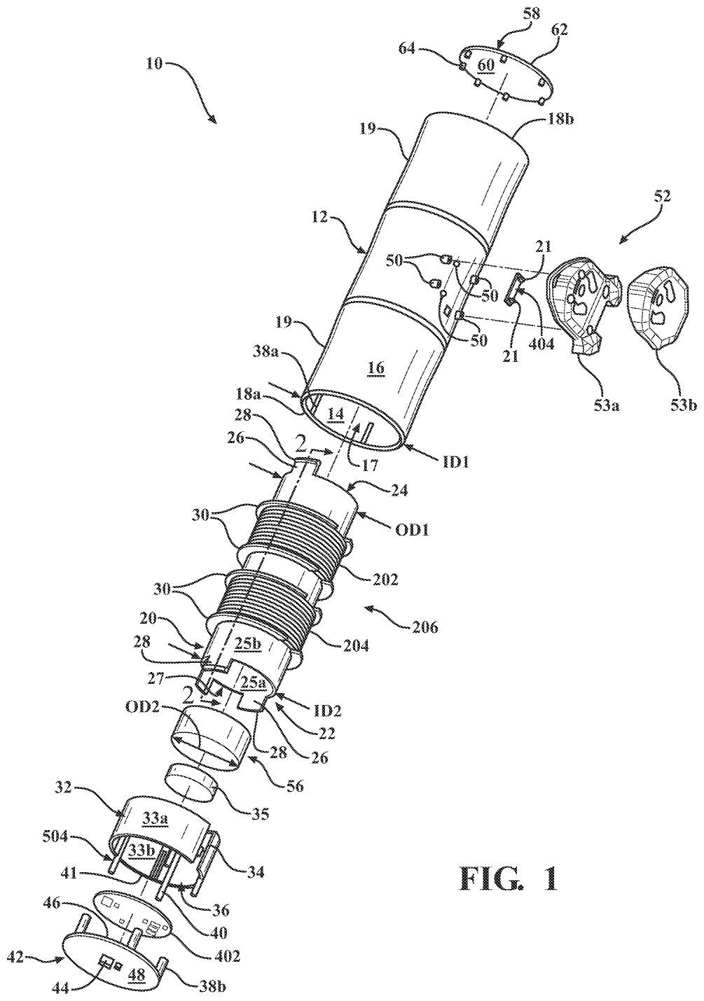

Referring initially to FIG. 1, a perspective exploded view of an energy conversion device 10 is schematically depicted. The energy conversion device 10 includes a housing 12 having an inner surface 14 and an outer surface 16. The housing 12 is tubular has a pair of opposing ends 18a, 18b. The pair of opposing ends 18a, 18b are open or exposed such that a bore 17 extends there through. The bore 17 has an inner diameter ID1, as best depicted in FIG. 1. In some embodiments, the outer surface 16 may coated with, or formed from, a chrome silver shell bamboo style. That is, the housing 12 may be a mineral plastic composite that has electric conducting properties and the outer surface 16 may include silver and/or chrome finishing. In some embodiments, the outer surface 16 may include a camo color finishing, and/or other color spectrums and color palates are possible. Further, the outer surface 16 may include a plurality of arched regions 19, curvature regions, taper regions, and/or the like so to assist a user with gripping and/or holding of the housing 12. The inner surface 14 may extend the length of the housing 12 to define the bore 17. Further, the inner surface 14 may include a plurality of elongated slots 38a. The elongated slots 38a are configured to receive a plurality of elongated members 38b of a first end cap 42, as discussed in greater detail below.

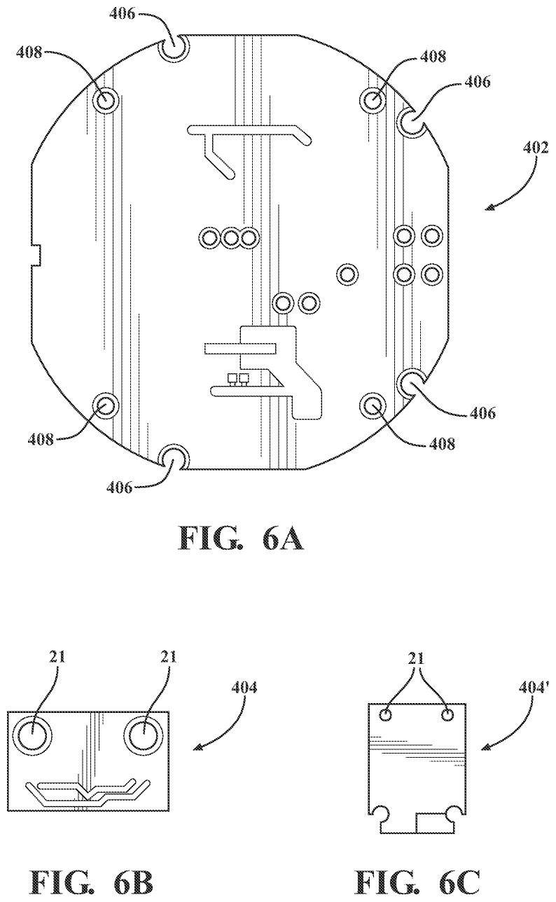

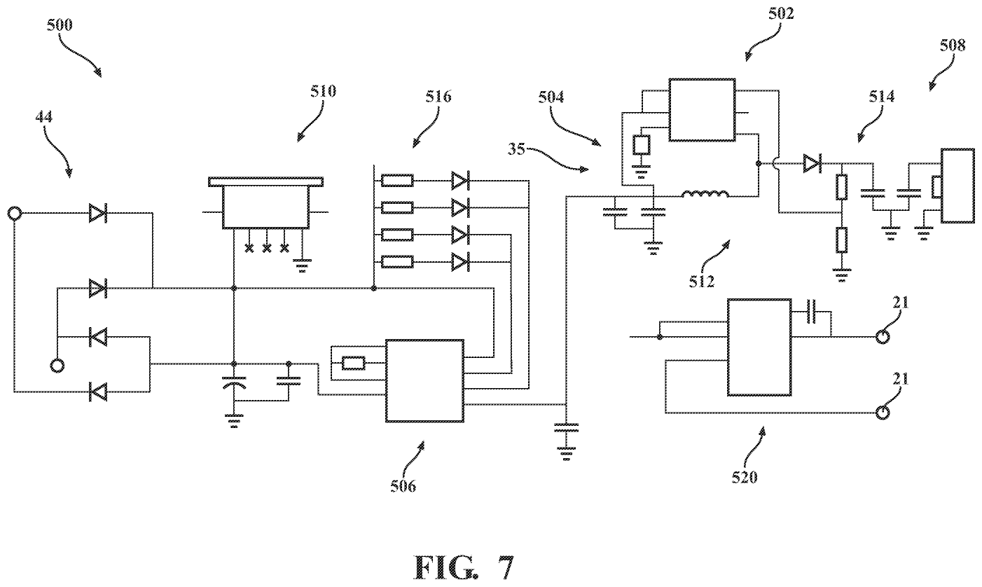

Still referring to FIG. 1 and now also to FIG. 6B, a plurality of light emitting diodes (LEDs) 21 are mounted to the outer surface 16 of the housing 12. The LEDs 21 are in electrical communication with a second circuit board 404, such as a printed circuit board, and an example electrical control circuit 500 (FIG. 7), as described in greater detail herein. As such, the second circuit board 404 may be communicatively coupled to the first circuit board 402 (FIG. 6A). The LEDs 21 may have a plurality of colors to signify different states of the energy conversion device 10. For example, the LEDs 21 may emit a red light to indicate when the charging load is full within the storage assembly (e.g., the battery 35). In addition, the LEDs 21 may emit a blue light signifying that the energy conversion device 10 is charging the energy storage assembly 504 (FIG. 7). As such, there may be a plurality of colors that each may signify to the user a different operation of the energy conversion device 10. It should be appreciated that the LEDS 21 may be mounted or communicatively coupled to a second circuit board 404, such as a second printed circuit board.

Further, the LEDs 21 may be part of, or incorporated into, a design or an external figurine 52 mounted to the housing 12 by a plurality of receiving protrusions 50 mounted and extending from the outer surface 16 of the housing 12. The receiving protrusions 50 may be a unitary construction with the housing 12, plastic welded to the outer surface 16 of the housing 12, and/or the like. Further, the receiving protrusions 50 may be configured to accept a fastener such as a bolt, a screw, a rivet, adhesive, weld, epoxy, and/or the like. In a non-limiting example, the receiving protrusions 50 may be threaded so to accept a threaded fastener, such as the screw. As such, the figurine 52 and/or the second circuit board 404 may be mounted to the outer surface 16 of the housing 12. For example, and without limitation, the figurine 52 may be a two piece panda face 53a, 53b and including the second circuit board 404 such that the LEDs 21 are mounted to the second circuit board 404 and positioned imitate eyes of the panda face shape. In other embodiments, other animals face shapes may be used such as, without limitation, cat, lion, dolphin, dog, and/or the like.

In another embodiment, a second circuit board 404′ may be mounted to the outer surface 16 of the housing 12 and configured with the LEDs 21.

With reference now to FIGS. 1 and 4, an insert sleeve 20 having a tubular or barrel shape with a base end 22, an opposite upper end 24, an inner surface 25a defining a through bore 27, and an outer surface 25b is schematically depicted. The through bore 27 has an inner diameter ID2, as best illustrated in FIG. 1. Further, the insert sleeve has an outer diameter OD1, as best depicted in FIG. 1, which is less than the inner diameter ID1 such that the insert sleeve may be received within the bore 17 of the housing 12.

Disposed on each end 22, 24 is a plurality of resilient members 26 that are spaced apart and extend from the base end 22 a same length such that each of the plurality of resilient members 26 are arranged in a uniform pattern. This is non-limiting and the spacing between each of the plurality of resilient members 26 may be irregular. Further, in some embodiments, the length of each of the plurality of resilient members 26 may be different. In some embodiments, some or all of the plurality of resilient members 26 may have an angled protrusion portion 28. The resilient members 26 and the angled protrusion portion 28 are configured to latch, lock, and/or the like the insert sleeve 20 within the housing 12. As such, the resilient members 26 and the angled protrusion portion 28 mate with or have a complementary notch and/or the like on the inner surface 14 of the housing 12 that allows the insert sleeve 20 to lock into the housing 12 when the insert sleeve 20 is fully seated.

The insert sleeve 20 further includes a plurality of spaced apart partial rings 30. In some embodiments, each of the spaced apart partial rings 30 are uniformly spaced apart. Further each of the spaced apart partial rings 30 extend a same circumference around the outer surface 25b of the insert sleeve 20. This is non-limiting and each spaced apart partial rings 30 may be spaced apart in a non-uniform arrangement and/or may not extend from the outer surface 25b of the insert sleeve 20 at different lengths or distances.

The spaced apart partial rings 30 may be sequenced and configured for a first coil 202 and a second coil 204 so to form the at least one coil solenoid 206. The first and second coils 202, 204 may each be formed from copper and/or the like and may be a wire having a gauge such as, without limitation, 0.28 inches. However, this is non-limiting and any conductive material may be used. Further, the gauge is non-limiting and the gauge of the conductive material may be larger or smaller than 0.28 inches. Further, it should be appreciated that while the first coil 202 and the second coil 204 are illustrated in the depicted embodiment, this is non-limiting and there may be there may be more or less coils.

The first and second coils 202, 204 may disposed between at least two of the spaced apart partial rings 30, respectively, so to be separated by at least a width of the spaced apart partial rings 30. The first and second coils 202, 204 wrap or coil the insert sleeve 20 such that the first and second coils 202, 204 wrap or coil the insert sleeve 20 perpendicularly to a length (e.g., the through bore 27) of the insert sleeve 20. In some embodiments, the first and second coils 202, 204 may be wound in the same direction. In other embodiments, the first and second coils 202, 204 may be wound in opposite directions.

Further, in some embodiments, the first and second coils 202, 204 may be formed to wrap in a sequential arrangement with no overlap of the conductive material (e.g., the copper wire). In other embodiments, the first and second coils 202, 204 may be formed to wrap in a sequential and stacked arrangement where some of the conductive material (e.g., the copper wire) is positioned to extend over other coils of the same conductive material to stack in a vertical direction. That is, the conductive material (e.g., the copper wire) may be continuously wrapped around the outer surface 25b of the insert sleeve 20 building upon the previous loops of the conductive material (e.g., the copper wire).

In some embodiments, a mineral plastic and/or a chemical deposit is disposed between the each or some of spaced apart partial rings 30 and may be in place of, or replace, the first and the second coils 202, 204 to create or form the at least one coil solenoid 206. As such, in these embodiments, the mineral plastic and/or the chemical deposit preforms similar to the first and the second coils 202, 204, as described in detail herein. Further, in other embodiments, open air sections for laser motion may be used without the first and the second coils 202, 204. In embodiments, the insert sleeve 20 may be an formed from an enhanced highly polarized mineral composite material. For example, and without limitation, materials and/or fillers may include piezoelectric polymers, polyolefins, isotactic polypropylene, high density polyethylene, polyethylene MDPE Tipelin, Tourmaline, Sillikolloid, glass beads, and other inorganic and organic materials.

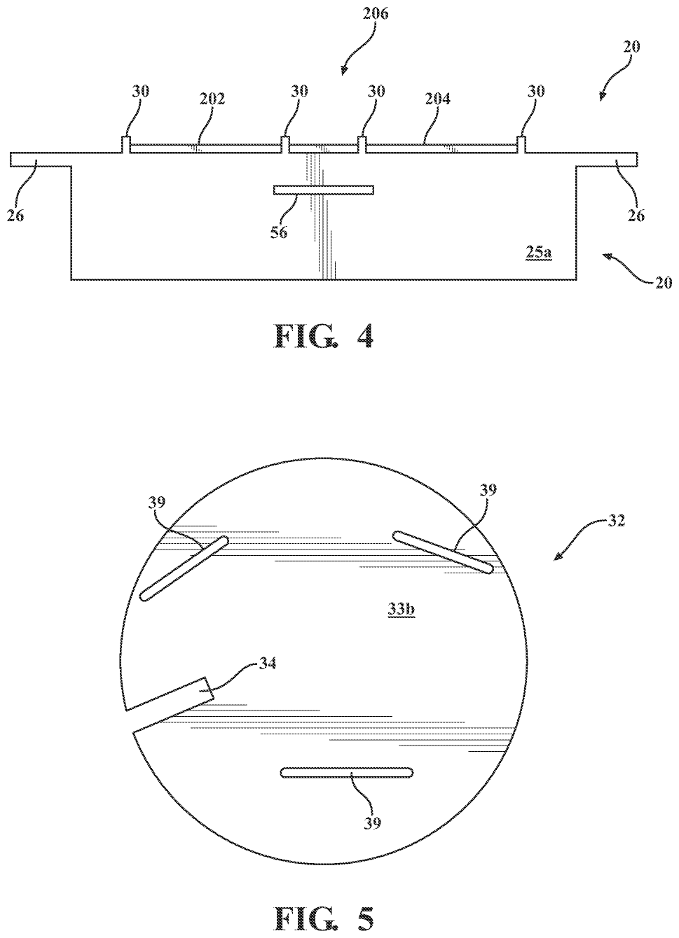

With reference now to FIGS. 1 and 5, a battery compartment 32 is configured to engage with the base end 22 of the insert sleeve 20 such as slidably engage and/or in a snap fit configuration. The battery compartment 32 may include an inner surface 33a and an opposite outer surface 33b. Further, the battery compartment 32 may include a battery 35, a through opening 34, a cavity 36, a plurality of slots 39, and a plurality of spacer members 40. The inner surface 33a may have corresponding notches that latch or lock the resilient members 26 and/or the angled protrusion portion 28 of the base end 22 to the inner surface 33a within the cavity 36 of the battery compartment 32.

The cavity 36 of the battery compartment 32 may further house an energy storage assembly 504 (FIG. 7) and an electrical communication port 41 that may be communicatively coupled to the battery 35. The electrical communication port 41 may be a cable, wire, etch, and/or the like. The electrical communication port 41 may be communicatively coupled to the first circuit board 402 (FIG. 6A), to an electrical connection interface 44 such as a universal serial bus outlet, and/or the like. As such the electrical connection interface 44 may be communicatively coupled to an electronic device 70 of a user via any known device 72 (e.g., cables, wires, and the like) to provide a charging energy from the electrical connection interface 44 of the energy conversion device 10 to the electronic device 70, as discussed in greater detail herein.

The plurality of spacer members 40 maintain the desired spacing between the battery compartment 32 and the first end cap 42 at a predetermined distance such that the energy storage assembly 504 (FIG. 7) within the battery compartment 32 does not make contact with the first circuit board 402 (FIG. 6A). In some embodiments, the energy storage assembly 504 (FIG. 7) and/or the battery compartment 32 are not needed and the energy conversion device 10 may connect directly with an external system that is in need of energy. In this embodiment, the energy conversion device 10 provides the required kinetic and electromagnetic energy directly to the external system. As such, it should be appreciated that the energy conversion device 10 may provide a direct or continuing power and energy without the energy storage assembly 504 (FIG. 7).

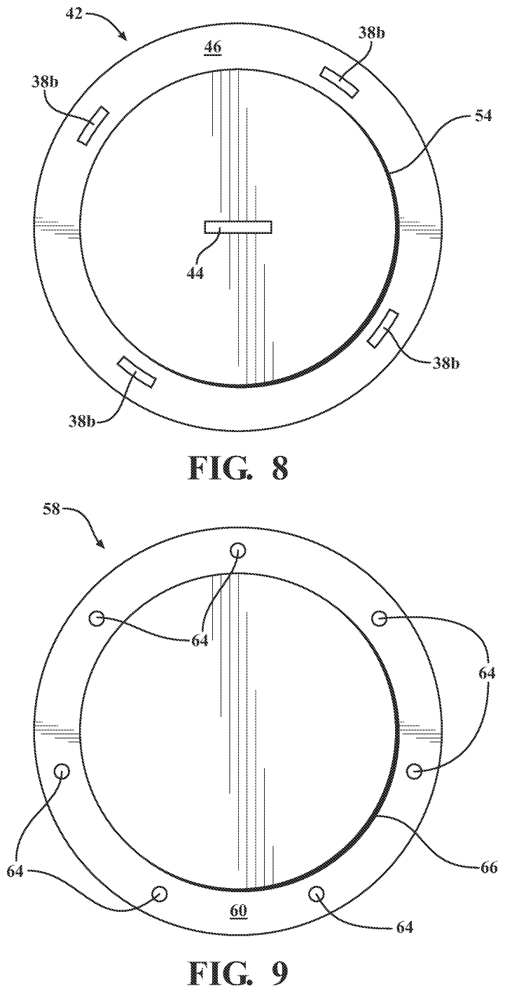

With reference now to FIGS. 1 and 8, the first end cap 42 has an inside surface 46 and opposite outside surface 48. The first end cap 42 is configured to house the external electrical connection interface 44 such as the universal serial bus outlet, or other compatible external electrical connection interface (e.g., USB type A, USB type C, mini USB, Lighting, Micro USB, Type B, and the like). Further, the first end cap 42 is configured to receive the battery compartment 32, or at least a portion of the battery compartment 32 such as a portion of the plurality of spacer members 40 so snap fit or couple the first end cap 42 to the battery compartment 32. The first end cap 42 further includes the plurality of elongated members 38b extending from the inside surface 46. The plurality of elongated members 38b are received by the plurality of elongated slots 38a of the housing 12 so to releasable attach the battery compartment 32 and the insert sleeve 20 into the housing 12 such as in a snap fit configuration. The first end cap 42 may be formed from a mineral plastic, such as an iron ore composite. A first iron core 54 or coil may be mounted on the inside surface 46 to extend therefrom. The first iron core 54 may be configured with a predetermined force to repel a magnet 56 during operation of the energy conversion device 10, as discussed in greater detail herein.

With reference now to FIGS. 1 and 9, a second end cap 58 has an inside surface 60 and an opposite outside surface 62. A plurality of resilient locking members 64 are disposed around a circumference of the second end cap 58. The second end cap 58 is configured to releasably attach to the housing 12 of the energy conversion device 10 in a snap fit configuration. The second end cap 58 is formed from a mineral plastic, such as an iron ore composite. A second iron core 66 or coil may be mounted on the inside surface 60. The second iron core 66 may be configured with a predetermined force to repel the magnet 56 during operation of the energy conversion device 10.

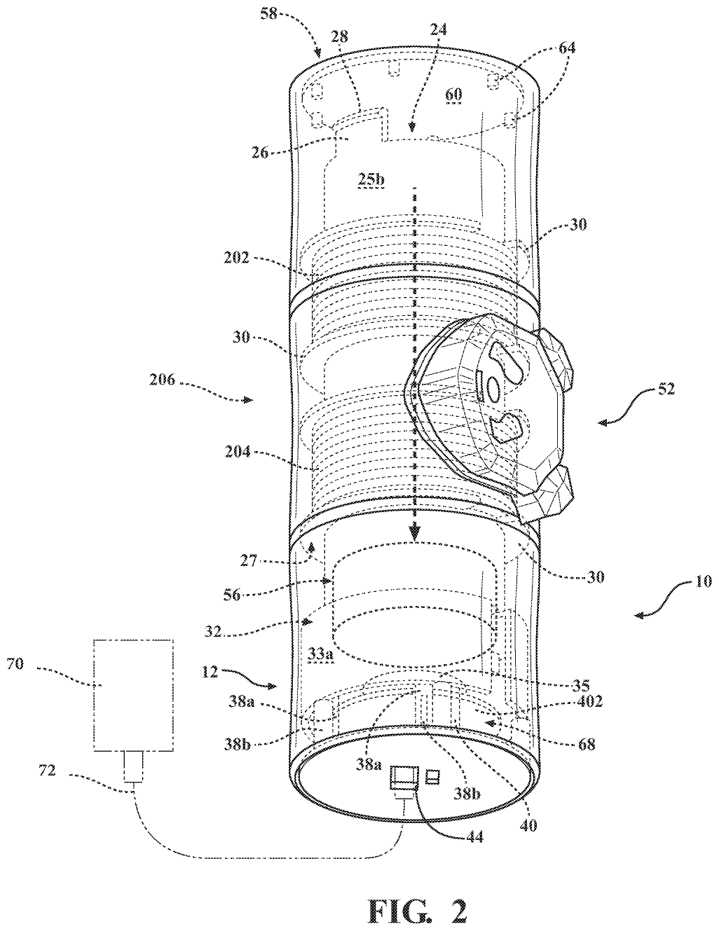

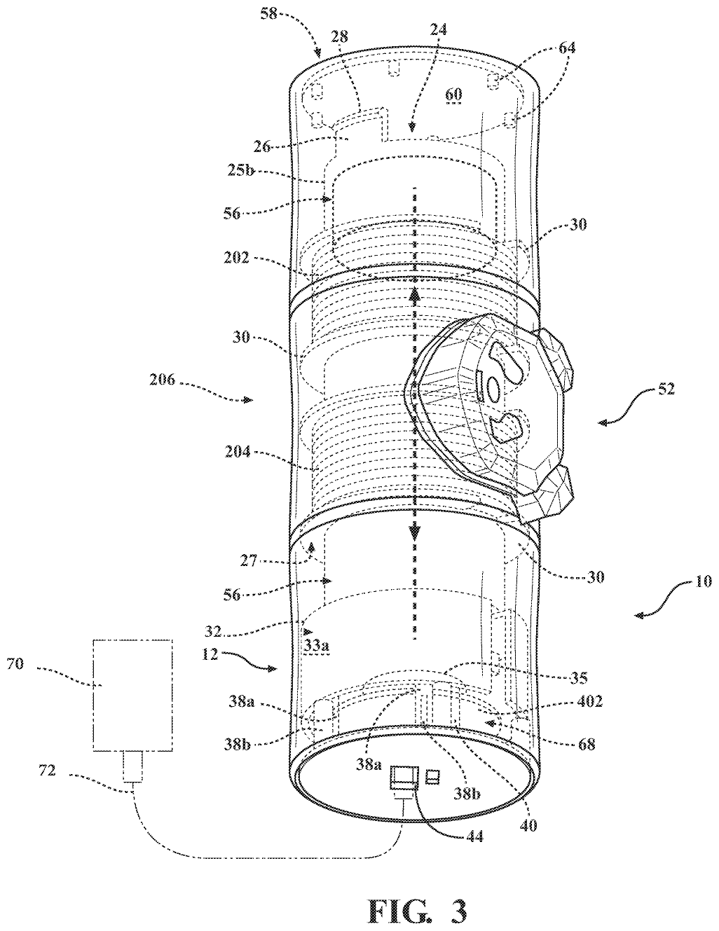

With reference back to FIGS. 1 and 2, the magnet 56 is positioned between the base end 22 and the upper end 24 of the insert sleeve 20. The magnet 56 has an outer diameter OD2 that is less than or smaller than the inner diameter ID2 of the through bore 27. As such, the magnet 56 may be configured to traverse, or travel along or back and forth the length of the through bore 27 and inner surface 25a of the insert sleeve 20. In some embodiments, the magnet 56 may be a N52 Neyodium disk. This is non-limiting and the magnet 56 may be any other suitable magnetic composite. By way of example and not by limitation, the magnet 56 may have a 0.5 inch thickness and a 1.3 inch diameter. The magnet 56 is not limited to the disk shape or to a particular size.

In embodiments, the magnet 56 is repelled by both the first and second iron coils 54, 66 of the first and the second end caps 42, 58 such that the magnet 56 is suspended within the insert sleeve 20 and thus the housing 12 between the first end cap 42 and the second end cap 58. As such, the magnet 56 may be independent free floating within the through bore 27. This arrangement permits for the magnet 56 to pass the at least one coil solenoid 206 forming a kinetic and electromagnetic energy through induction. In some embodiments, the magnet 56 may be disposed within a track or a guide within the insert sleeve 20 such that the magnet 56 is guided instead of free floating. As such, the first and the second end caps 42, 58 need not include the first and second iron coils 54, 66 because the magnet 56 does not need to the repulsive forces to oscillate or pass the at least one coil solenoid 206 forming a kinetic and electromagnetic energy through induction.

With reference to FIGS. 1 and 6A, the first circuit board 402 may be housed in a space or gap 68 between the first end cap 42 and the battery compartment 32 created by the plurality of spacer members 40. As such, the first circuit board 402 may include a plurality of notches 406 and a plurality of apertures 408 so to engage with the plurality of spacer members 40 and/or the plurality of elongated members 38b respectively to keep or retain the first circuit board 402 such that the first circuit board 402 is stationary during the operation of the energy conversion device 10. The first circuit board 402 may be communicatively coupled to the battery compartment 32 and/or to the first end cap 42, as discussed in greater detail herein.

With reference to FIG. 7, the example electrical control circuit 500 is schematically depicted. The example electrical control circuit 500 may include an example battery charge controller 502, the energy storage assembly 504, an example processor 506, an example transceiver 508, an example power transmitter 510, a plurality of example rectifiers 512, an example regulator/converter 514, an example plurality of antennas 516, the external electrical connection interface 44, and the LEDs 21. The example electrical control circuit 500 is configured to rectify an AC voltage from the first coil 202 within the housing 12 into a DC voltage used to charge the energy storage assembly 504. As such, the example electrical control circuit 500 is electrically connected to the energy storage assembly 504 and to the first and second coils 202, 204. The example electrical control circuit 500 includes rectifiers 512 configured to convert an AC voltage or signal from the first and second coils 202, 204 of the insert sleeve 20 into a DC voltage. After rectification, the battery charge controller 502 may be configured to direct, store, and/or the like, the DC voltage to the battery of the energy storage assembly 504.

The battery charge controller 502 may be an integrated circuit, an electronic control unit, a central processing unit (CPU), and the like, for performing the functions as described herein. As such, the battery charge controller 502 may be configured to receive, analyze and process data, perform calculations and mathematical functions, convert data, generate data, control device components, and the like. The battery charge controller 502 may include one or more processors, and other components, for example one or more memory modules that stores logic that is executable by the one or more processors and a database. Each of the one or more processors may be a controller, an integrated circuit, a microchip, central processing unit or any other computing device. The one or more memory modules may be non-transitory computer readable medium and may be configured a RAM, ROM, flash memories, hard drives, and, or any device capable of storing computer-executable instructions, such that the computer-executable instructions can be accessed by the one or more processors. The computer-executable instructions may include logic or algorithms, written in any programming language of any generation such as, for example machine language that may be directly executed by the processors, or assembly language, object orientated programming, scripting languages, microcode, and the like, that may be compiled or assembled into computer-executable instructions and storage on the one or more memory modules. Alternatively, the computer-executable instructions may be written in hardware description language, such as logic implemented via either a field programmable gate array (FPGA) configuration or an application specific integrated circuit (ASIC), all their equivalents

The example regulator/converter 514 is configured to convert the current and/or voltage from the battery 35 into one or more electrical signals for transmission via the external electrical connection interface 44. The example processor 506 may include logic or computer readable instructions that specify what current/voltage is to be output based, for example, on which interface is being used or a type of electronic mobile device. The example processor 506 may be part of or an electronic control unit, a central processing unit (CPU), and the like, for performing the functions as described herein. As such, the example processor 506 may be configured to receive, analyze and process data, perform calculations and mathematical functions, convert data, generate data, control device components, and the like. The example processor 506 may be communicatively coupled to one or more memory modules that stores logic that is executable by the example processor 506 and a database. The example processor 506 may also be part of an integrated circuit, a microchip, central processing unit or any other computing device. The one or more memory modules may be non-transitory computer readable medium and may be configured a RAM, ROM, flash memories, hard drives, and, or any device capable of storing computer-executable instructions, such that the computer-executable instructions can be accessed by the example processor 506. The computer-executable instructions may include logic or algorithms, written in any programming language of any generation such as, for example machine language that may be directly executed by the example processor 506, or assembly language, object orientated programming, scripting languages, microcode, and the like, that may be compiled or assembled into computer-executable instructions and storage on the one or more memory modules. Alternatively, the computer-executable instructions may be written in hardware description language, such as logic implemented via either a field programmable gate array (FPGA) configuration or an application specific integrated circuit (ASIC), all their equivalents.

Moreover, the example electrical control circuit 500 may be configured to communicate with mobile electronic devices not being charged. The example processor 506 may be communicatively coupled to the transceiver 508 that enables wireless communication or LTE data (i.e. RFID, Bluetooth, NFC, Wi-Fi, and/or the like) with other charging devices. The example processor 506 is configured to communicate with the example power transmitter 510 that may be received by the transceiver via the antennas 516. Further wireless transmission of charging power may be possible through light laser transmission with the tubular energy flow system, radio frequency, and future delivery systems that one skilled in the art would appreciate.

It should also be appreciated that the energy storage assembly 504 may include the battery 35, such as a rechargeable battery. For example, and without limitation, a nickel-cadmium battery (NiCd), a lithium ion battery, and/or the like. The battery is configured to take independent charges and AC charges from the shaking induced energy converted in the first circuit board 402. The battery 35 may further include a plurality of capacitors that will help maintain the storage of the electrical energy.

The LEDS 21 may be may be electrically coupled to a second example processor 520. The second example processor 520 may be electrically coupled to the example processor 506 or to the example battery charge controller 502 so that the second example processor 520 may control the LEDS 21 to emit a certain color light when the energy conversion device 10 is charging or when the energy conversion device 10 is charged or may be it is ready for use. The second example processor 520 may be part of or an electronic control unit, a central processing unit (CPU), and the like, for performing the functions as described herein. As such, the second example processor 520 may be configured to receive, analyze and process data, perform calculations and mathematical functions, convert data, generate data, control device components, and the like. The second example processor 520 may be communicatively coupled to one or more memory modules that stores logic that is executable by the second example processor 520 and a database. The second example processor 520 may also be part of an integrated circuit, a microchip, central processing unit or any other computing device. The one or more memory modules may be non-transitory computer readable medium and may be configured a RAM, ROM, flash memories, hard drives, and, or any device capable of storing computer-executable instructions, such that the computer-executable instructions can be accessed by the second example processor 520. The computer-executable instructions may include logic or algorithms, written in any programming language of any generation such as, for example machine language that may be directly executed by the second example processor 520, or assembly language, object orientated programming, scripting languages, microcode, and the like, that may be compiled or assembled into computer-executable instructions and storage on the one or more memory modules. Alternatively, the computer-executable instructions may be written in hardware description language, such as logic implemented via either a field programmable gate array (FPGA) configuration or an application specific integrated circuit (ASIC), all their equivalents.

Other embodiments may include additional or fewer analog and/or digital components and/or surface mount components (i.e. resistors, capacitors, diodes, amplifiers, and/or the like).

The processes of generating kinetic and electromagnetic energy with the energy conversion device 10 will now be described. The kinetic and electromagnetic energy is generated through induction from the magnet 56 passing between first and second coils 202, 204 of the at least one coil solenoid 206. That is, as the energy conversion device 10 is manually moved in a repetitive manner, such as shaken by a user, which in turn oscillates the magnet 56 between the repulsive forces generated by the first and second iron cores 54, 66 of the first and second end caps 42, 58, respectively. As such, the repulsive forces generated by the iron cores 54, 66 of the first and second end caps 42, 58 provide a predetermined force to maintain a gap or space between the magnet 56 and the first end cap 42 and the second end cap 58. It should be appreciated that these special gaps may vary based on the size of the magnet 56, the size and/or amount of metal of the iron cores 54, 66, and the like.

It should be appreciated that while the device is manually moved, such as shaken, the magnet 56 oscillates in any direction (i.e., left-right, right-left, up-down, down-up, rotate around an axis, flip over an axis or multiple axes, and/or the like, and in combination thereof). Further, in embodiments, the magnet 56 could be propelled into any direction (i.e., left-right, right-left, up-down, down-up, rotate around an axis, flip over an axis or multiple axes, and/or the like, and in combination thereof) caused by a mechanism configured to react to a pushbutton, a switch, a trigger, and/or the like that would start or simulate the magnet 56 in motion or movement. As such, in this embodiment, the magnet may be oscillated in any direction more efficiently than a user simply shaking the energy conversion device 10.

During movement of the magnet 56, current is generated in the first and second coils 202. 204 from electromagnetic coupling with the magnet 56. The current causes a voltage to form across the first and second coils 202, 204. Generally, a movement of the magnet 56 toward the first coil 202 generates a positive voltage across the first coil 202 and a negative voltage across the second coil 204. Similarly, movement of the magnet 56 toward the second coil 204 generates a negative voltage across the first coil 202 and a positive voltage across the second coil 204. The first and second coils 202, 204 are rectified separately to maintain the positive and negative voltages.

As such, the arrangement and embodiments described herein permit high voltage and mAh to be created, captured, and converted for real use in energy need situations.

Additionally, it should be appreciated that when the magnet 56 is moving across the gap of the first and second coils 202, 204, the voltages induced between any neighboring metal coils or coil solenoids have phases approximately opposite to each other. The neighboring coil solenoids are connected in series but reversely wired for phase-matching, increasing the voltage output by capturing difference between two opposite phased waveform.

It should also be appreciated that the housing 12, the insert sleeve 20, the first and second end caps 42, 58 and the battery compartment 32 may take on various shapes and sizes other than what is described and illustrated herein.

It should be appreciated that device described herein stores or harvests both kinetic and electromagnetic energy such that the harvested energy may be used to charge a personal electronic device. The device includes a housing, a circuit board (e.g., a PCB), a circuit assembly, a magnet, a coil solenoid, two end caps, an energy storage assembly, and at least one light emitting diode configured to emit light during the harvesting process and/or when there is sufficient energy stored. The device is configured to be shaken, which in turn creates energy from the magnet passing between at least one metal coil of the coil solenoid. The device rectifies the energy and converts the energy into a DC voltage for use in applications such as charging personal electronic mobile devices. Accordingly, the device described herein is configured to collect piezoelectricity, induction energy, electromagnetic energy, and/wireless energy and store the electricity and transfer the energy to a personal electronic device for independent charging.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

It is claimed:

1. An energy conversion device comprising:
a housing having a bore;
an insert sleeve having a through bore, the insert sleeve positioned within the bore of the housing, the insert sleeve having an exterior surface and a plurality of spaced apart partial rings extending from the exterior surface, at least one coil solenoid positioned on the exterior surface, the at least one coil solenoid configured to generate a predetermined controlled magnetic field;
a magnet configured to traverse the through bore to generate a kinetic and an electromagnetic energy through induction with the predetermined controlled magnetic field; and
a control circuit communicatively coupled to the at least one coil solenoid, the control circuit having:
a battery configured to be recharged by the kinetic and the electromagnetic energy and discharged by an electrical connection interface,
a processor configured to control a charging and discharging of the battery; and
at least one light emitting diode configured to display different colors based on a current status of the energy conversion device,
wherein when the magnet is manually forced to traverse the through bore in a repetitive manner, an oscillation of the magnet generates the kinetic and the electromagnetic energy through induction with the predetermined controlled magnetic field of the at least one coil solenoid such that the battery is energized to provide a charging energy to the electrical connection interface to provide an electrical charge to an external personal electronic device.

2. The energy conversion device of claim 1, wherein the at least one coil solenoid is formed from a first coil and a second coil, the first coil is spaced apart from the second coil.

3. The energy conversion device of claim 2, wherein the first coil and the second coil are formed from a copper wire.

4. The energy conversion device of claim 1, wherein the magnet is formed from N52 Neyodium material.

5. The energy conversion device of claim 1, wherein the housing further includes a figurine extending therefrom, the figurine includes the at least one light emitting diode.

6. The energy conversion device of claim 5, wherein the figurine is generally an animal face shape and the at least one light emitting diode is a pair of light emitting diodes to imitate eyes of the animal face shape.

7. The energy conversion device of claim 1, further comprising:
a first end cap configured to cover one end of the housing; and
a second end cap configured to cover the other end of the housing,
wherein the first end cap further includes the electrical connection interface.

8. The energy conversion device of claim 7, wherein:
an inside surface of the first end cap includes a first iron core; and
an inside surface of the second end cap includes a second iron core,
wherein the first iron core and the second iron core are configured to repel the magnet in a direction away from the first iron core and the second iron core, respectively.

9. The energy conversion device of claim 8, wherein the magnet is free floats within the through bore between the the first iron core and the second iron core.

10. An energy device comprising:
a housing having a bore;
an insert sleeve having a through bore, the insert sleeve positioned within the bore of the housing, the insert sleeve having an exterior surface and at least one coil solenoid positioned on the exterior surface;
a magnet configured to traverse the through bore to generate an energy through induction with the at least one coil solenoid; and
a control circuit having a battery and an electrical connection interface, the control circuit communicatively coupled to the at least one coil solenoid,
wherein when the magnet is manually forced to traverse the through bore in a repetitive manner, an oscillation of the magnet generates the energy through induction with the at least one coil solenoid such that the battery is energized to provide a charging energy to an external personal electronic device via the electrical connection interface.

11. The energy device of claim 10, further comprising at least one light emitting diode configured to display different colors based on a current status of the energy device.

12. The energy device of claim 11, wherein the housing further includes a figurine extending therefrom, the figurine includes the at least one light emitting diode.

13. The energy device of claim 10, wherein the at least one coil solenoid is formed from a first coil and a second coil, the first coil is spaced apart from the second coil.

14. The energy device of claim 13, further comprising:
a first end cap configured to cover one end of the housing; and
a second end cap configured to cover the other end of the housing,
wherein the first end cap further includes the electrical connection interface.

15. The energy device of claim 14, wherein:
an inside surface of the first end cap includes a first iron core; and
an inside surface of the second end cap includes a second iron core,
wherein the first iron core and the second iron core are configured to repel the magnet in a direction away from the first iron core and the second iron core, respectively.

16. The energy device of claim 15, wherein the magnet free floats within the through bore between the first iron core and the second iron core.

17. The energy device of claim 13, wherein the first coil and the second coil are formed from a copper wire.

18. The energy device of claim 10, wherein the magnet is formed from N52 Neyodium material.
